(19) United States
(12) Patent Application Publication
(10) Pub. No.: US 2008/0005882 A1
(43) Pub. Date: Jan. 10, 2008

(54) Film cutter apparatus and method of forming

(76) Inventors: Ian Kaiser, Malibu, CA (US); Sean Neiberger, South Pasadena, CA (US); Paul Vegliante, Franklin Lakes, NJ (US)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 11/800,943

(22) Filed: May 8, 2007

Related U.S. Application Data
(60) Provisional application No. 60/798,486, filed on May 8, 2006.

(51) Int. Cl. B23P 11/00

(52) U.S. Cl. 29/434; 83/455

(57) ABSTRACT

The present invention relates to a film cutter apparatus and method of forming same including a button slide cutter slideably movable within a track formed as a blister shell. The track provides a channel below a pair of raised edges and end edges formed integral with the pair of raised edges. The button slide cutter is formed of a button and base. The base houses a blade. In one embodiment, the button is snapped onto the base.

### CROSS REFERENCE TO RELATED APPLICATION

This application claims the benefit of U.S. Provisional Patent Application No. 60/798,486, filed May 8, 2006, the entirety of which is hereby incorporated by reference into this application

### BACKGROUND OF THE INVENTION

Film cutter apparatus are known. U.S. Patent Application No. 2002/0117038 describes a film cutter apparatus including rails which provide cling to a plastic film received thereover for holding the film in place during and after cutting of the film.

Blister sealing methods are known in which a product or consumer item is contained within cavities formed in a packaging surface as a result of a thermoforming process. U.S. Pat. No. 5,379,572 describes a blister sealing packaging system and method in which two thermoplastic sheet materials are sealed together.

It is desirable to provide a film cutter apparatus including rails formed by a blister forming method which can be attached onto a dispenser box in flat form or assembled.

### SUMMARY OF THE INVENTION

The present invention relates to a film cutter apparatus and method of forming same including a button slide cutter slideably movable within a track formed as a blister shell. The track provides a channel adjacent a pair of raised edges and end edges formed integral with the pair of raised edges. The button slide cutter is formed of a button and base. The base houses a blade. In one embodiment, the button is snapped onto the base.

The blister shell and button slide cutter can be shipped inside a box including a roll of film. The blister shell and button can be attached to the box by the user after the purchase of the box.

In an alternate embodiment, the blister shell and button slide cutter can be attached to a flap coupled to a box having film to be cut. The flap can be loaded inside the box during shipment and is folded over a front portion of the box. The flap can be adhered to the box.

Alternatively, the button slide cutter can be attached to a portion of the box in flat form before the box is assembled. Thereafter, the box can be assembled before or after shipping to a customer. The blister shell can be formed by positive forming, negative forming, thermosealing, high frequency sealing and resistance sealing methods.

The invention will be more fully described by reference to the following drawings.

### BRIEF DESCRIPTION OF THE DRAWINGS

FIG. 1 is a perspective view of a film cutter apparatus according to the present invention.

FIG. 2 is a top plan view of the blister shell.

FIG. 3 is a vertical cross section of the blister shell.

FIG. 4 is a side elevational view of the blister shell.

FIG. 5A is a side and top elevational view of the button slide cutter.

FIG. 5B is a top elevational view of the button slide cutter.

FIG. 5C is a cross section view of the button slide cutter within a channel of the blister shell.

FIG. 5D is a perspective view of assembly of the button slide cutter.

FIG. 6 is a vertical cross section of an end of the blister shell.

FIG. 7A is a schematic diagram of housing of a blister shell and slide cutter within a roll of film in a box.

FIG. 7B is a schematic diagram of housing of a blister shell and slide cutter within a box.

FIG. 7C is a schematic diagram of feeding film through a slot in the box.

FIG. 7D is a schematic diagram of attachment of the blister shell and slide cutter to a top of the box.

FIG. 7E is a schematic diagram of removal of film from the box.

FIG. 7F is a schematic diagram of covering of an object with the film and cutting of the film.

FIG. 7G is a schematic diagram of an alternate embodiment of an attachment of the blister shell and slide cutter to a side of the box.

FIG. 7H is a cross section view of the button slide cutter being snap fitter into the blister shell.

FIG. 7I is a schematic diagram of an alternate embodiment of the blister shell and button slide cutter to a flap of the box.

FIG. 7J is a schematic diagram showing the flap of FIG. 7I in a closed position.

FIG. 8 is a schematic diagram of a blade used in the button slide cutter.

FIGS. 9A-9G illustrate a method and apparatus for positive forming of a blister shell.

FIGS. 10A-10H illustrate an alternate method and apparatus for positive forming of a blister shell.

FIGS. 11A-11H illustrate an alternate method and apparatus for positive forming of a blister shell.

FIGS. 12A-12F illustrate a method and apparatus for negative forming of a blister shell.

FIGS. 13A-13F illustrate an alternate method and apparatus for negative forming of a blister shell.

FIGS. 14A-14F illustrate an alternate method and apparatus for negative forming of a blister shell.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

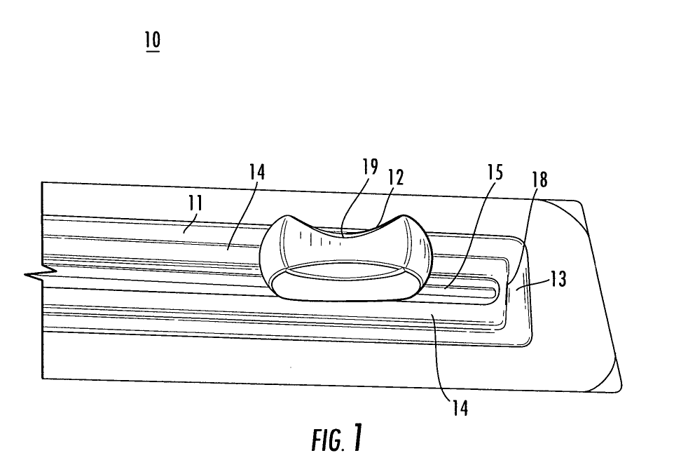

The present invention relates to film cutter apparatus 10, as shown in FIG. 1. Film cutter apparatus 10 includes blister shell 11 and button slide cutter 12. Blister shell 11 can be made of a paper board, plastic or foil material backing.

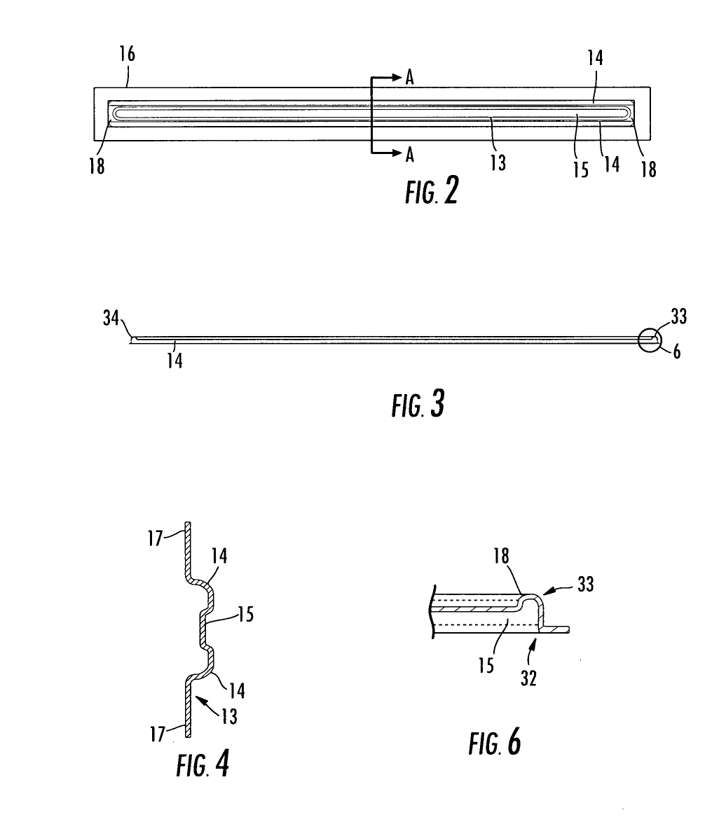

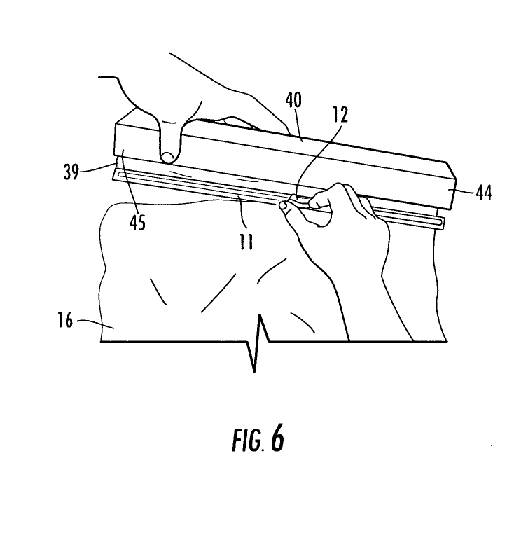

Blister shell 11 forms track 13, as shown in FIGS. 2-4. Track 13 includes a pair of raised edges 14. Channel 15 is formed adjacent raised edges 14 and extends between raised edges 14. Film 16 is dispensed from a roll (not shown) and is pulled across raised edges 14. Film 16 can be any plastic film such as food service wrap. Track 13 can have a length corresponding to the width of any size film.

Raised edges 14 include end edges 18 at either end of track 13 for retaining button slide cutter 12 within channel 15. End edges 18 can be integral with raised edges 14.

Blister shell 11 can be formed of a thermoplastic sheet. For example, the thermoplastic material can comprise polyethylene and polypropylene or other thermoplastic olefin polymer or vinyl polymer, such as ethylene vinyl acetate or polyvinyl halide. The thermoplastic material can be a polyvinyl chloride sheet material. At least raised edges 14 of blister shell 11 or blister shell 11 in its entirety can be formed of a material which provides an attractive or cling property to cling film 16 to raised edges 14 and to help hold film 16 flat before and after cutting. For example, blister shell 11 can be formed of rubber, polyvinyl chloride, silicon elastimer and combinations thereof. In one embodiment, the polyvinyl chloride can have at least 1%, alternatively, less than 15% plasticizer.

In one embodiment, track 13 can include adhesive 17 on a bottom surface thereof. Adhesive 17 can be covered by a removable strip cover. Track 13 can be coupled to a box with adhesive 17 before or after shipping as described below.

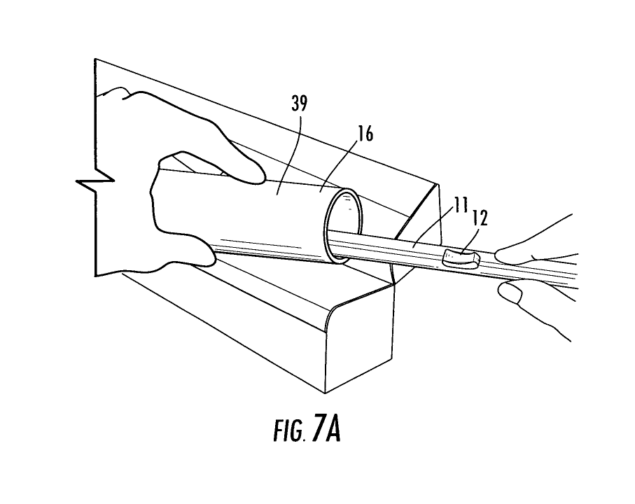

Button slide cutter 12 is formed of button 19 and base 20, as shown in FIGS. 5A-5D. Button 19 can be contacted by a finger of a user for moving button slide cutter 12 bilaterally in channel 15. Lower portion 22 of base 20 is received in channel 15. Lower portion 22 of base 20 can have a rectangular or flat shape which slides in channel 15. Base 20 and button 19 houses blade 21. Upper portion 23 of base 20 includes slot 24 for receiving lower portion 25 of blade 21. Button 19 includes cavity 26 for receiving upper portion 27 of blade 21. During assembly of button slide cutter 12, lower portion 25 of blade 21 is received in slot 24 and cavity 26 is received over upper portion 27 of blade 21. Button 19 is snapped onto base 20 for coupling base 20 to button 19.

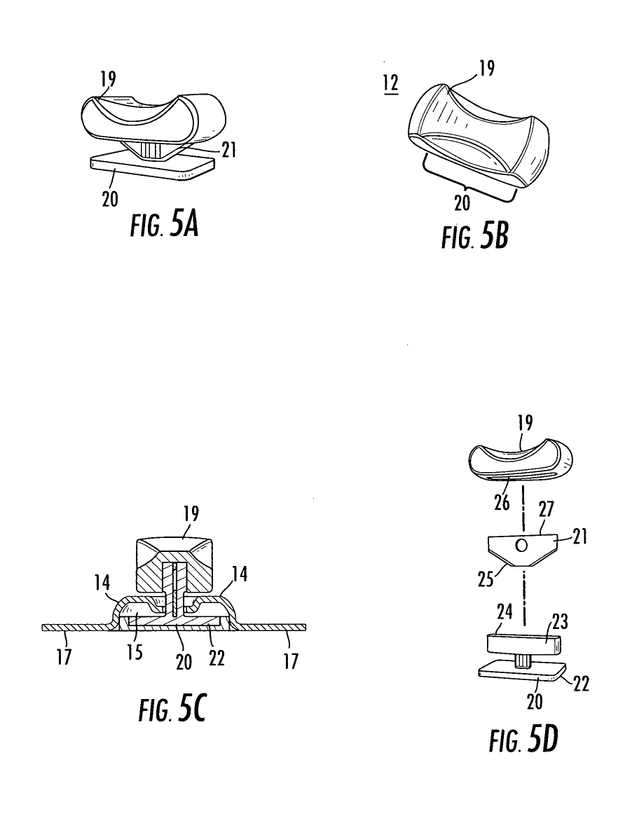

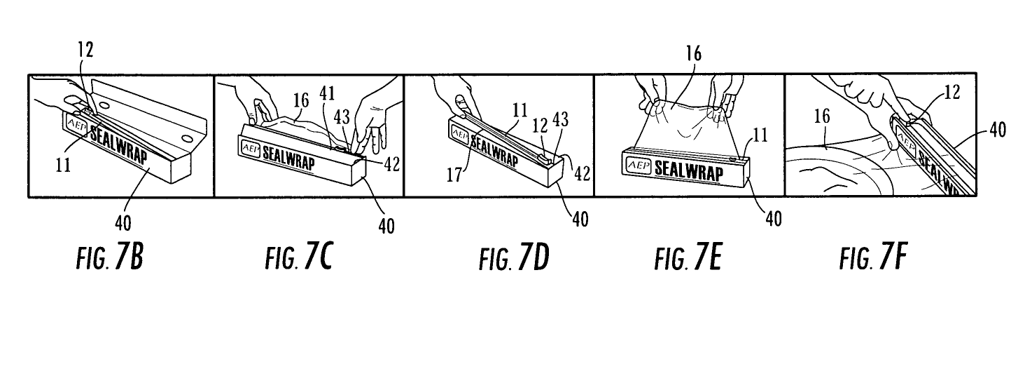

In one embodiment, detail 32 extends from end 33 and/or end 34 of end edge 18 at either end of track 13, as shown in FIGS. 3 and 6. Detail 32 extends into channel 15 for holding button slide cutter 12 at a respective end 33 or end 34 of channel 15 for a next use. Detail 32 provides enough pressure to hold button slide cutter 12 in place without making it cumbersome to slide button slide cutter 12 out of detail 32.

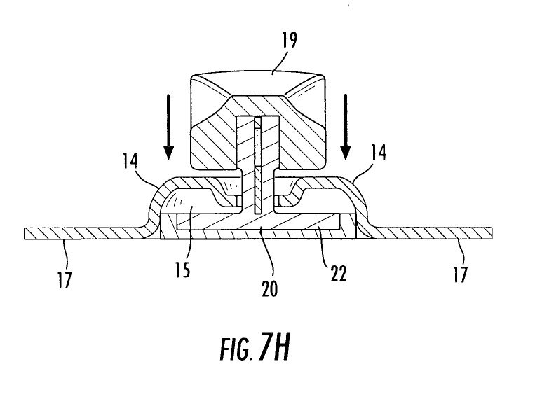

Film cutter apparatus 10 is attached to box 40 before or after shipping, as shown in FIGS. 7A-7I. In one embodiment, blister shell 11 and button slide cutter 12 can be housed inside roll 39 of film 16, as shown in FIG. 7A. Alternatively, blister shell 11 and button slide cutter 12 can be housed inside box 40, as shown in FIG. 7B. In one embodiment, perforation 41 can be provided on top 42 of box 40 forming slot 43 to receive film 16, as shown in FIG. 7C. An adhesive cover is removed to attach adhesive 17 formed on a bottom or surface of track 13 to top 42 of box 40 adjacent slot 43, as shown in FIG. 7D. During operation of button slide cutter 12, film 16 is pulled up and over an item and thereafter button slide cutter 12 can slide in both directions for cutting film 16, as shown in FIGS. 7E and 7F.

Alternatively, blister shell 11 can be attached with an adhesive strip 44 attached to a side portion 45 of box 40, as shown in FIG. 7G. Adhesive strip 44 can be attached to box 40 before shipping. Alternatively, adhesive strip 44 can include a peel away cover. A user can remove the peel away cover from adhesive strip 44 and adhere blister shell 11 to adhesive strip 44 thereby adhering blister shell 11 to side portion 45 of box 40 after shipping. During operation, film 16 is pulled from roll 39 over side portion 45 of box 40 and button slide cutter 12 can slide in both directions for cutting film 16.

In an alternate embodiment, button slide cutter 12 and blister shell 11 are individually received within box 40. Button slide cutter 12 is attached to blister shell 11 after shipping by snapping button 19 onto base 20 retained in channel 15 in FIG. 7H.

In an alternate embodiment, button slide cutter 12 is preassembled to blister shell 11, as shown in FIGS. 7I and 7J. Blister shell 11 and button slide cutter 12 are attached to flap 46. Flap 46 is hinged to box 40. Flap 46 can be located inside box 40 during shipment and is folded down over side portion 45 of box 40 by the end user for installation. Blister shell 11 is attached to rear side 49 of flap 46. Accordingly flap 46 allows for blister shell 11 to be attached directly to box 40 during the box assembly process. In one embodiment, blister shell 11 can be coupled to box 40 using heat sealing. Flap 46 can include two die cut holes 47 to provide easy access to film 16.

In one embodiment, flap 46 can include an adhesive tape 48 on a frontside 51. A peel away cover is adhered to adhesive tape 48. Adhesive tape 48 can be peeled away from the peel away cover to allow consumers to adhere flap 46 to box 40.

In an alternate embodiment, box 40 can include adhesive 50 which is exposed when box 40 is opened for the first time. Thereafter a user folds flap 46 down onto adhesive 50 for attachment of flap 46 to side portion 45 of box 40.

Alternatively, flap 46 can include tuck in corners or tabs for attaching flap 46 to box 40 without use of an adhesive.

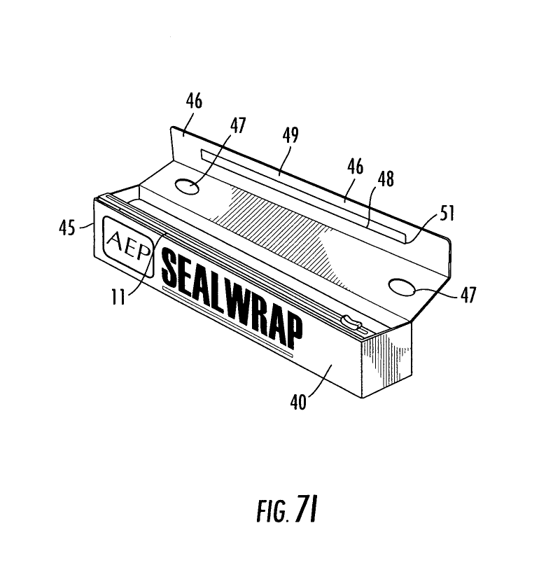

Blade 21 can be manufactured using 420 stainless steel having a thickness of about 0.004 inch, as shown in FIG. 8. It has been found that blades having a thickness of about 0.004 inch cut far superior than the industry standard of 0.15 inch.

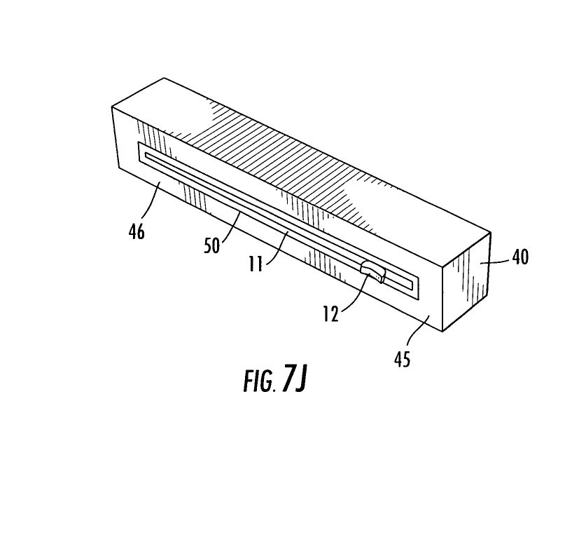

FIGS. 9A-9G illustrate a method and apparatus for positive forming blister shell 11. Positive forming apparatus 100 includes upper plug 102, upper frame 103 and lower frame 104. Upper plug 102 is formed as a positive copy of blister shell 11. Upper plug 102 is received in upper frame 103. Upper plug 102 and lower frame 104 are linked to an individual stroke cylinder (not shown) for opening and closing positive forming apparatus 100. In a first stage, positive forming apparatus 100 is opened to move lower frame 104 away from upper plug 102 as shown in FIG. 9A. Film 105 is heated. Film 105 is placed under upper plug 102 or upper plug 102 is moved over film 105. Lower frame 104 is moved upwardly in the direction D₁ for closing lower frame 104 to upper frame 103, as shown in FIG. 9B. Upper plug 102 is moved in direction D₂ for moving upper plug 102 into film 105, as shown in FIG. 9C. In FIG. 9D, vacuum 106 is applied to positive forming apparatus 100 for forming blister shell 11. Thereafter, upper plug 102 is moved in the direction of arrow D₃ for opening upper plug 102, as shown in FIG. 9E. Lower frame 104 is moved in the direction of arrow D₄ for opening lower frame 104, as shown in FIG. 9F. In FIG. 9G, formed blister shell 11 is transported from positive forming apparatus 100.

Button 19 and base 20, shown in FIGS. 5A-5D, can be manufactured in two sections. Blade 21 can be inserted, molded or assembled into base 20. The two piece design allows parts to be assembled using automated equipment during the manufacturing of blister shell 11. Once blister shell 11 is formed, button 19 and base 20 can be snapped together and fastened into channel 15 of blister shell 11.

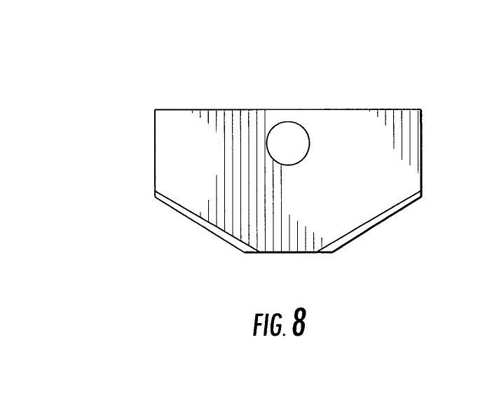

FIGS. 10A-10H illustrate an alternate method and apparatus for positive forming blister shell 11. In a first stage, positive forming apparatus 110 is opened to move lower frame 104 away from upper plug 102 as shown in FIG. 10A. Film 105 is heated. Film 105 is placed under upper plug 102 or upper plug 102 is moved over film 105. Lower frame 104 is moved upwardly in the direction D₁ for closing lower frame 104 to upper frame 103, as shown in FIG. 10B. Vacuum preforming is performed to apply vacuum 108 to film 105 in FIG. 10C. Upper plug 102 is moved in direction D₂ for closing upper plug 102 into film 105, as shown in FIG. 10D. In FIG. 10E, vacuum 106 is applied to positive forming apparatus 100 for finish vacuum forming of blister shell 11. Thereafter, upper plug 102 is moved in the direction of arrow D₃ for opening upper plug 102, as shown in FIG. 10F. Lower frame 104 is moved in the direction of arrow D₄ for opening lower frame 104, as shown in FIG. 10G. In FIG. 10H, formed blister shell 11 is transported from positive forming apparatus 110.

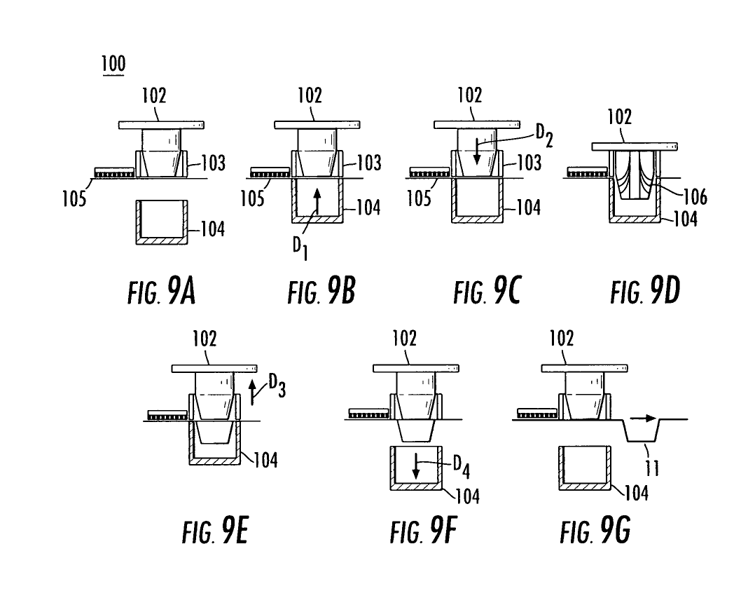

FIGS. 11A-11H illustrate an alternate method and apparatus for positive forming blister shell 11. In a first stage, positive forming apparatus 120 is opened to move lower frame 104 away from upper plug 102 as shown in FIG. 11A. Film 105 is heated. Film 105 is placed under upper plug 102 or upper plug 102 is moved over film 105. Lower frame 104 is moved upwardly in the direction D₁ for closing lower frame 104 to upper frame 103, as shown in FIG. 11B. Compressed air finish forming is performed to apply compressed air 109 to film 105 in FIG. 11C. Upper plug 102 is moved in direction D₂ for closing upper plug 102 into film 105, as shown in FIG. 11D. In FIG. 11E, vacuum 106 is applied to positive forming apparatus 100 for finish vacuum forming blister shell 11. Thereafter, upper plug 102 is moved in the direction of arrow D₃ for opening upper plug 102, as shown in FIG. 11F. Lower frame 104 is moved in the direction of arrow D₄ for opening lower frame 104, as shown in FIG. 11G. In FIG. 11H, blister shell 11 is transported from positive forming apparatus 120.

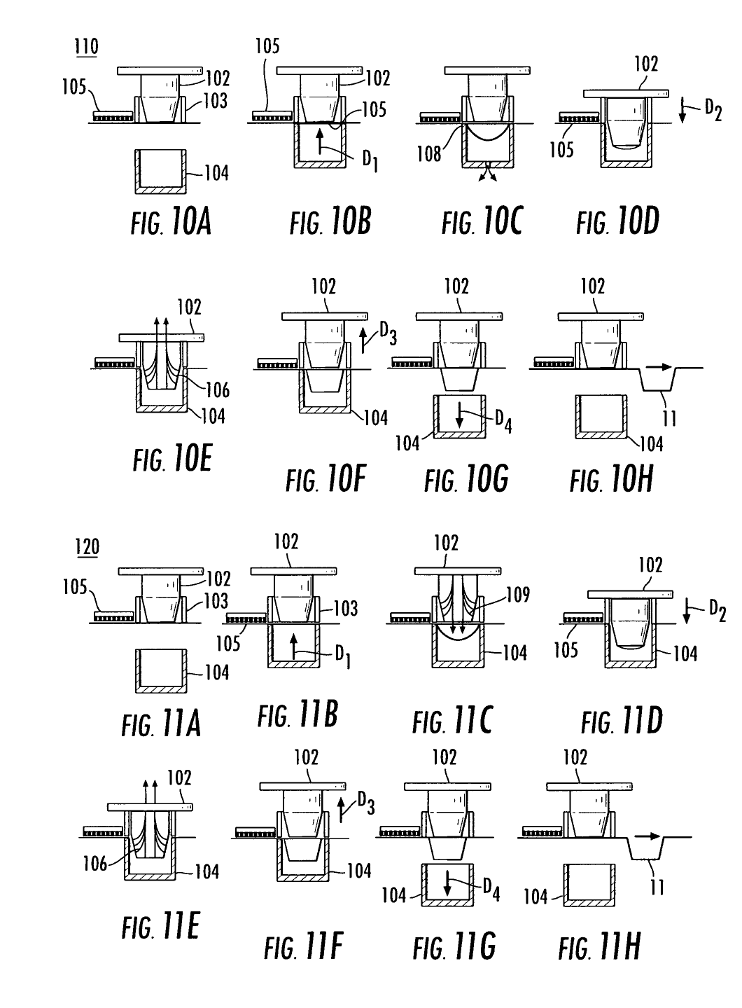

FIGS. 12A-12F illustrate a method and apparatus for negative forming blister shell 11. Negative forming apparatus 200 includes lower forming tool 202 and upper plate 203. Lower forming tool 202 is formed as a negative copy of blister shell 11. Lower forming tool 202 is received in upper plate 203. Lower forming tool 202 and upper plate 203 are linked to an individual stroke cylinder (not shown) for opening and closing negative forming apparatus 200. In a first stage, negative forming apparatus 200 is opened to move lower forming tool 202 away from upper plate 203 as shown in FIG. 12A. Film 205 is heated. Film 205 is placed under over lower forming tool 202 or lower forming tool 202 is moved over film 205. Lower forming tool 202 is moved upwardly in the direction D₁₁ for closing lower forming tool 202 to upper plate 203, as shown in FIG. 12B. Compressed air preforming is performed to apply compressed air 206 to film 205 in FIG. 12C. In FIG. 12D, compressed air finish forming is performed to apply compressed air 208 to film 205 for forming blister shell 11. Thereafter, lower forming tool 202 is moved in the direction of arrow D₁₂ for opening lower forming tool 202, as shown in FIG. 12E. In FIG. 12F, blister shell 11 is transported from negative forming apparatus 200.

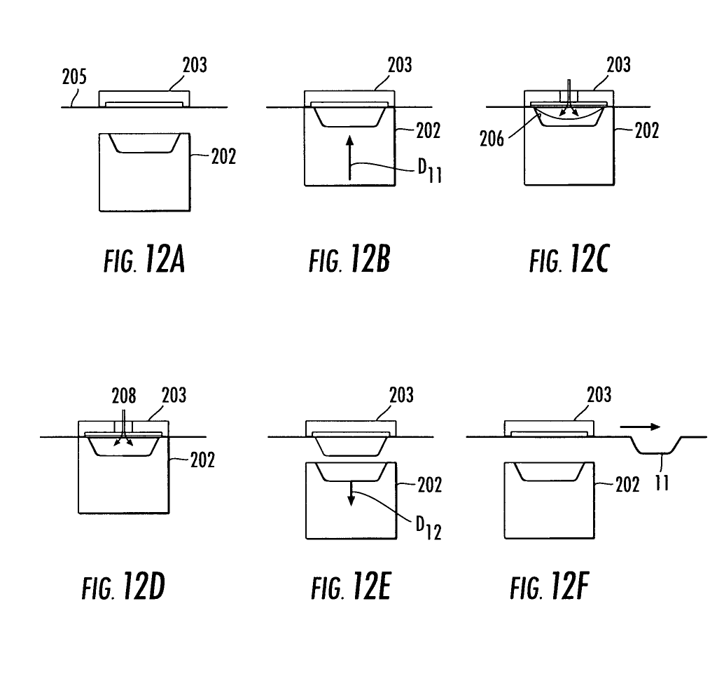

FIGS. 13A-13F illustrate a method and apparatus for negative forming blister shell 11. Negative forming apparatus 210 includes lower forming tool 202 and upper plate 203. Lower forming tool 202 is formed as a negative copy of blister shell 11. Lower forming tool 202 is received in upper plate 203. Lower forming tool 202 and upper plate 203 are linked to an individual stroke cylinder (not shown) for opening and closing negative forming apparatus 200. In a first stage, negative forming apparatus 200 is opened to move lower forming tool 202 away from upper plate 203 as shown in FIG. 13A. Film 205 is heated. Film 205 is placed under over lower forming tool 202 or lower forming tool 202 is moved over film 205. Lower forming tool 202 is moved upwardly in the direction D₁₁ for closing lower forming tool 202 to upper plate 203, as shown in FIG. 13B. Compressed air preforming is performed to apply compressed air 206 to film 205 in FIG. 13C. In FIG. 13D, vacuum finish forming is performed to apply vacuum 250 to film 205 for forming blister shell 11. Thereafter, lower forming tool 202 is moved in the direction of arrow D₁₂ for opening lower forming tool 202, as shown in FIG. 13E. In FIG. 13F, blister shell 11 is transported from negative forming apparatus 210.

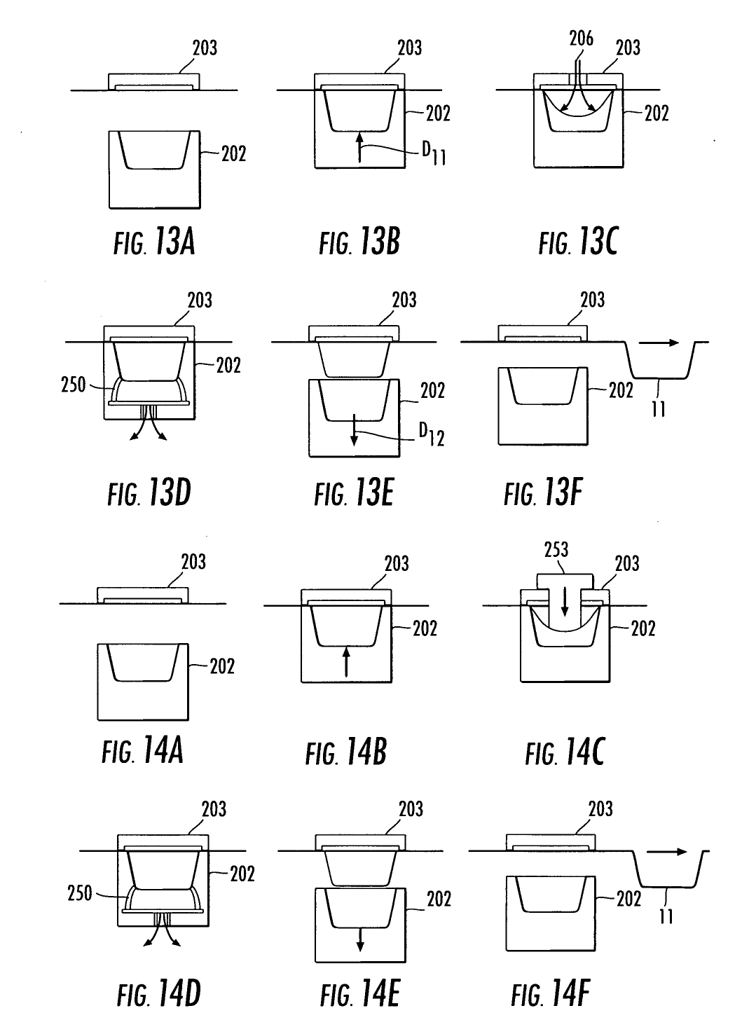

FIGS. 14A-14F illustrate a method and apparatus for negative forming blister shell 11. Negative forming apparatus 200 includes lower forming tool 202 and upper plate 203. Lower forming tool 202 is formed as a negative copy of blister shell 11. Lower forming tool 202 is received in upper plate 203. Lower forming tool 202 and upper plate 203 are linked to an individual stroke cylinder (not shown) for opening and closing negative forming apparatus 200. In a first stage, negative forming apparatus 200 is opened to move lower forming tool 202 away from upper plate 203 as shown in FIG. 14A. Film 205 is heated. Film 205 is placed under over lower forming tool 202 or lower forming tool 202 is moved over film 205. Lower forming tool 202 is moved upwardly in the direction D₁₁ for closing lower forming tool 202 to upper plate 203, as shown in FIG. 14B. Prestretching plug preforming is performed to prestretch film 205 by inserting plug 252 in FIG. 14C. In FIG. 14D, vacuum finish forming is performed to apply vacuum 250 to film 205 for forming blister shell 11. Thereafter, lower forming tool 202 is moved in the direction of arrow D₁₂ for opening lower forming tool 202, as shown in FIG. 14E. In FIG. 14F, blister shell 11 is transported from negative forming apparatus 210.

Other methods for blister forming include thermosealing. In thermosealing, the sealing joint is heated from the top by the sealing tool. Both materials are sealed by the application of heat and pressure.

High-frequency (RF or ultrasonic) sealing can also be used for blister forming. In high-frequency sealing, pressurized high-frequency waves in ultrasonic range are supplied to the sealing joint. This high-frequency causes vibration of the molecules of the materials. After short heating of the materials, there is sealing with one another.

Resistance (impulse) sealing can also be used for blister forming. The sealing tools are equipped with conducting paths of high electric resistance. The conducting paths are heated very quickly if current is applied. The conducting paths give the heat to the materials which are sealed with one another.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A film cutter apparatus for cutting plastic wrap comprising:
a blister shell forming a track, said blister shell including a pair of raised edges and a channel extending between said raised edges; and
a blade housing for housing a blade, said blade housing being received in said channel,
wherein said blade housing is bilaterally slidable within said channel.

2. The apparatus of claim 1 wherein said blister shell further comprises end edges formed integral with either end of said raised edges.

3. The apparatus of claim 2 wherein said track further comprises a detail extending from a first said end edge and/or a second said end edge of said track, said blade housing contacting said detail for holding said blade housing at said first end edge and/or said second end edge.

4. The apparatus of claim 1 wherein said lower portion of said blade housing has a rectangular or flat shape.

5. The apparatus of claim 1 wherein said blade housing is formed of a button and a base, said base and said button housing said blade, and a lower portion of said blade housing is received in said channel.

6. The apparatus of claim 5 wherein an upper portion of said base includes a slot for receiving a lower portion of said blade and said button includes a cavity for receiving an upper portion of said blade.

7. The apparatus of claim 5 wherein said button is snapped onto said base for coupling said base to said button.

8. The apparatus of claim 1 wherein said blister shell is formed of a material which provides an attractive or cling property to said plastic wrap received over said blister shell for attracting said plastic wrap to said blister shell and holding said plastic wrap to said blister shell before and after cutting of said plastic wrap.

9. The apparatus of claim 1 wherein said material is selected from the group consisting of rubber, polyvinyl chloride, said polyvinyl chloride comprising less than 15% plasticizer, silicon elastimer, and combinations thereof.

10. The apparatus of claim 1 further comprising a box for housing said plastic wrap, said blister shell adapted to be attached to said box.

11. The apparatus of claim 10 further comprising an adhesive strip coupled to said blister shell wherein said adhesive strip is used to attach said blister shell to said box.

12. The apparatus of claim 10 further comprising an adhesive strip coupled to said box wherein said adhesive strip is used to attach said blister shell to said box.

13. The apparatus of claim 10 further comprising a flap hinged to said box said blister seal being attached to a rear side of said flap.

14. The apparatus of claim 13 wherein an adhesive tape is attached to a front side of said flap, wherein said tape adheres said flap to said box.

15. The apparatus of claim 14 further comprising a peel away cover adhered to said adhesive tape, wherein said peel away cover is peeled away from said adhesive tape and said adhesive tape adheres said flap to said box.

16. The apparatus of claim 10 wherein blister seal is attached to said box with heat sealing.

17. The apparatus of claim 1 wherein said blade has a thickness of about 0.004 inch.

18. A method of forming a film cutter apparatus comprising the steps of:
(a) providing a blister shell, said blister shell including a pair of raised edges and a channel extending between said raised edges; and
(b) receiving a blade housing for housing a blade with said channel said blister shell including a pair of raised edges and a channel extending between said raised edges.

19. The method of claim 18 wherein said blade housing comprises a button and a base, said base and said button housing said blade, and a lower portion of said blade housing is received in said channel.

20. The method of claim 19 further comprising the step of snapping said button to said base after said blade housing is received in said channel for coupling said base to said button.

21. The method of claim 18 further comprising the step of providing a detail extending from a first said end edge and/or a second said end edge of said track, said blade housing contacting said detail for holding said blade housing at said first end edge and/or said second end edge.

22. The method of claim 18 wherein said blister shell is formed of a material which provides an attractive or cling property to said plastic wrap received over said blister shell for attracting said plastic wrap to said blister shell and holding said plastic wrap to said blister shell before and after cutting of said plastic wrap.

23. The method of claim 22 wherein said material is selected from the group consisting of rubber, polyvinyl chloride, said polyvinyl chloride comprising less than 15% plasticizer, silicon elastimer, and combinations thereof.

24. The method of claim 18 further comprising the step of:
attaching said blister shell to a box for housing said plastic wrap.

25. The method of claim 24 wherein said step of attaching said blister shell to a box comprises an adhesive strip coupled to said blister shell wherein said adhesive strip attaches said blister shell to said box.

26. The method of claim 24 wherein said step of attaching said blister shell to a box further comprises an adhesive strip coupled to said box wherein said adhesive strip attaches said blister shell to said box.

27. The method of claim 24 further comprising a flap hinged to said box said blister seal being attached to a rear side of said flap.

28. The method of claim 27 wherein an adhesive tape is attached to a front side of said flap, wherein said tape adheres said flap to said box.

29. The method of claim 28 further comprising the step of providing a peel away cover attached to said adhesive tape and peeling away said peel away cover from said adhesive tape before said step of attaching a front side of said flap to said box.

30. The method of claim 18 wherein said blister shell is formed by positive forming.

31. The method of claim 18 wherein the blister shell is formed by the steps of:
receiving an upper plug being a positive copy of the blister shell in an upper frame;
moving apart a lower frame linked to said upper frame;
placing a blister shell film below said upper plug;
moving said lower frame upwardly for closing said lower frame to said upper frame;
moving said upper plug within said upper frame for moving said upper plug into said blister shell film;
applying a vacuum to said blister shell film for forming said blister shell; and
removing said blister shell by opening said lower frame and/or said upper frame.

32. The method of claim 33 wherein after the step of placing a blister shell film further comprising the step of vacuum performing to apply a vacuum to said blister shell film.

33. The method of claim 33 wherein after the step of placing a blister shell film further comprising the step of compressed air finish forming for applying compressed air to said blister shell film.

34. The method of claim 18 wherein said blister shell is formed by negative forming.

35. The method of claim 18 wherein the blister shell is formed by the steps of:
receiving a lower forming tool having a negative copy of the blister shell in an upper plate;
moving apart said lower forming tool linked to said upper plate;
placing a blister shell film over said lower forming tool;
moving said lower forming tool towards said upper plate;
applying compressed air finish forming to apply compressed air to said blister shell film for forming said blister shell; and
removing said blister shell by opening said lower forming tool and/or said upper plate.

36. The method of claim 35 wherein after said step of moving said lower forming tool towards said upper plate, further comprising the step of compressed air performing for applying compressed air to said blister seal film.

37. The method of claim 18 wherein said blister shell is formed by the steps of;
receiving a lower forming tool having a negative copy of the blister shell in an upper plate;
moving apart said lower forming tool linked to said upper plate;
placing a blister shell film for forming said blister shell over said lower forming tool;
moving said lower forming tool towards said upper plate;
compressed air performing for applying compressed air to said blister seal film;
applying a vacuum to said blister shell film for forming said blister shell; and
removing said blister shell by opening said lower forming tool and/or said upper plate.

38. The method of claim 18 wherein said blister shell is formed by the steps of;
receiving a lower forming tool having a negative copy of the blister shell in an upper plate;
moving apart said lower forming tool linked to said upper plate;
placing a blister shell film over said lower forming tool;
moving said lower forming tool towards said upper plate;
blister shell prestreched plug preforming to prestrech film by inserting a plug into said blister shell film;
applying a vacuum to said blister shell film for forming said blister shell; and
removing said blister shell by opening said lower forming tool and/or said upper plate.

39. The method of claim 24 wherein said blister shell is attached to said box by thermosealing.

40. The method of claim 24 wherein said blister shell is attached to said box with high frequency sealing.

41. The method of claim 24 wherein said blister shell is attached to said box with resistance sealing.
